(19) United States
(12) Patent Application Publication
(10) Pub. No.: US 2004/0243595 A1
(43) Pub. Date: Dec. 2, 2004

(54) Database management system

(76) Inventors: Zhan Cui, Colchester (GB); Dean Jones, Munich (DE)

Correspondence Address: NIXON & VANDERHYE, PC, 1100 N GLEBE ROAD, 8TH FLOOR, ARLINGTON, VA, 22201-4714, US

(21) Appl. No.: 10/490,706

(22) PCT Filed: Sep. 30, 2002
(86) PCT No.: PCT/GB02/04417

(30) Foreign Application Priority Data
Sep. 28, 2001 (EP) 01308298.7
Sep. 28, 2001 (EP) 01308305.0
Sep. 28, 2001 (EP) 01308331.6
Sep. 28, 2001 (EP) 01308332.4
Sep. 28, 2001 (EP) 01308333.2

(51) Int. Cl. G06F 17/00

(52) U.S. Cl. 707/100

(57) ABSTRACT

A database management system comprising a plurality of database resources (12, 14, 16) includes a query engine (30) which parses incoming queries into sub-queries directed at respective resources, (12, 14, 16) and compiles the sub-results into a final result. A node and a link representation is used to associate values from a different resources to address problems of semantic mismatch. In addition, ontologies are compiled for each resource against a shared ontology and a user/application ontology. As a result of the system, problems of semantic mismatch and query integration against distributed resources is overcome.

The invention relates to a database management system, in particular such a system for solving distributed queries across a range of resources.

In known systems, database retrieval from multiple sources suffers from problems of reconciliation of data between resources and resource or data incompatibility.

There is a need, therefore, for heterogeneous information system integration, in particular, structured data source integration such as databases and XML marked-up sources.

Information source integration has become increasingly important for electronic commerce as no modern businesses could do without the underlying information system support. In e-commerce, the underlying information systems are often developed independently by different companies. They have to be made interoperable in order to support cross-company, cross boundary business operations. For example, supply-chain management need to pass information/data from one system to another.

The difficulties of making heterogeneous information system interoperable are well studied. There are four kinds of heterogeneity to be dealt with when integrating information systems; system heterogeneity which includes incompatible hardware and operating systems, syntax heterogeneity which refers to different programming languages and data representations, structure heterogeneity which includes different data models such as relational and object-oriented models and semantic heterogeneity which refers to the meaning of terms.

Most available systems deal with the first three kinds of heterogeneity. The fourth one is the most difficult and no effective commercial solutions are available yet. Semantic heterogeneity has only been seriously investigated and addressed recently due to the maturity of distributed computing technologies and the growth of Internet, E-commerce and flexible enterprises. The difficulties in resolving the semantic heterogeneity include that: the same terms may be used to refer to different concepts or products; the different terms may be used to refer to similar concepts or products; the concepts are not explicitly defined; the relationships are not explicitly defined; differing points of view; and implicit assumptions.

These in turn cause difficulties in understanding data/information from disparate information sources and in fusing them.

Many technologies have been developed to tackle these types of heterogeneity. The first three categories have been addressed using technologies such as CORBA, DCOM and various middleware products. Recently XML has gained acceptance as a way of providing a common syntax for exchanging heterogeneous information. A number of schema-level specifications (usually as a Document Type Definition or an XML Schema) have recently been proposed as standards for use in e-commerce, including ebXML, BizTalk and RosettaNet. Although such schema-level specifications can successfully be used to specify an agreed set of labels with which to exchange product information it is wrong to assume that these solutions also solve the problems of semantic heterogeneity. Firstly, there are many such schema-level specifications and it cannot be assumed that they will all be based on consistent use of terminology. Secondly, it does not ensure consistent use of terminology in the data contained in different files that use the same set of labels. The problem of semantic heterogeneity will still exist in a world where all data is exchanged using XML structured according to standard schema-level specifications.

The most promising technology for dealing with semantic heterogeneity is ontology. This technology is mainly studied in academic communities. The focuses are on ontology definition, implementation and merging ontologies. There are some prototypes of using ontologies to solve heterogeneous information source integration. Known existing solutions using ontology technology include firstly a single shared ontology architecture: a single shared ontology acts as the common vocabulary and language. All the information sources are mapped to the shared ontology through wrappers. Users interact with the system using a user ontology which is mapped to the shared ontology. There is a query engine for composing and decomposing queries according to what sources are on-line. A variation of the above is that the system includes several subsystems of the above. A subsystem may use another subsystem. Subsystems could use different shared ontologies. There are mappings between shared ontologies used by different systems. The third type treats information sources as the first layer. It uses a second layer to process information from the first layer. The systems in the second layer are called mediators which provide information fusing services of some of the systems from the first layers. This can extend to third layers, fourth layers, and so on. However these mediators have to be pre-engineered with specific applications in mind. They do not deal with dynamic semantic mismatch reconciliation, that is, resoling semantic mismatch at run-time. The mediator-based approach does not offer the interoperability as required for example by E-commerce and flexible enterprises.

A solution to the problems of semantic heterogeneity should equip heterogeneous and autonomous software systems which the ability to share and exchange information in a semantically consistent way. This can of course be achieved in many ways, each of which might be the most appropriate given some set of circumstances. One solution is for developers to write code which translates between the terminologies of pairs of systems. Where the requirement is for a small number of systems to interoperate, this may be a useful solution. However, this solution does not scale as the development costs increase as more systems are added and the degree of semantic heterogeneity increases.

Aspects of the invention are set out in the attached claims.

The invention provides various advantages. In one aspect, the invention allows full database integration even in the case where a database includes a plurality of disparate database resources having differing ontologies.

In another aspect, the invention allows an integrated solution by finding and linking all database resources having the required elements for a specific database query.

In yet a further aspect, the invention allows a structured and efficient approach to solving a query by identifying sub-queries and dealing with each sub-query in turn or in parallel for integrating the sub-query results.

Embodiments of the invention will now be described, by way of example, with reference to the drawings, of which:

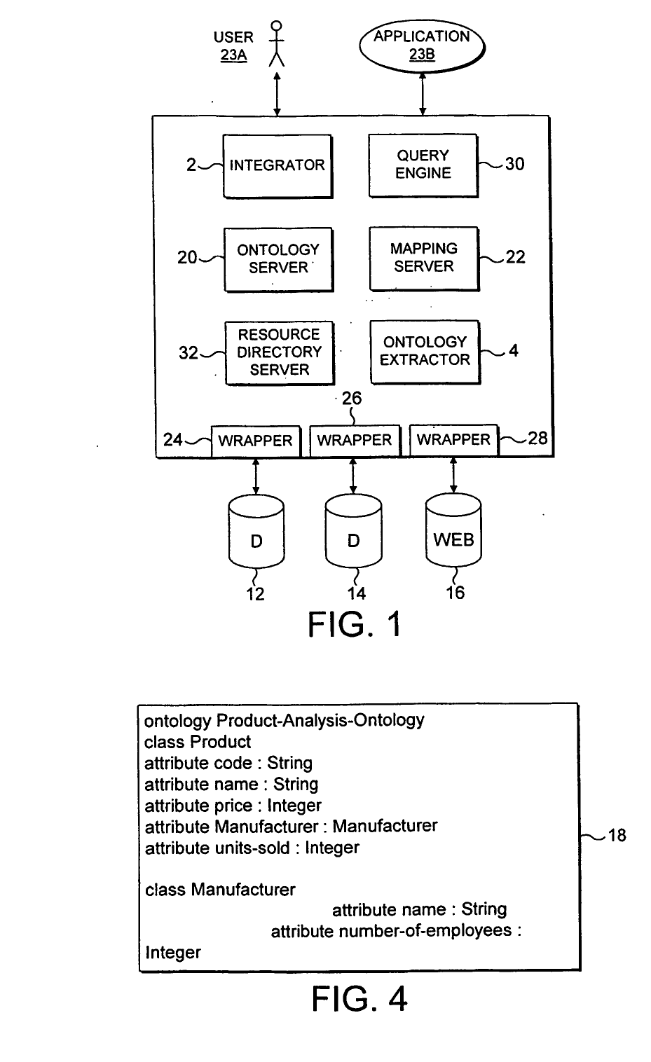

FIG. 1 is a block diagram of a system architecture to the present invention;

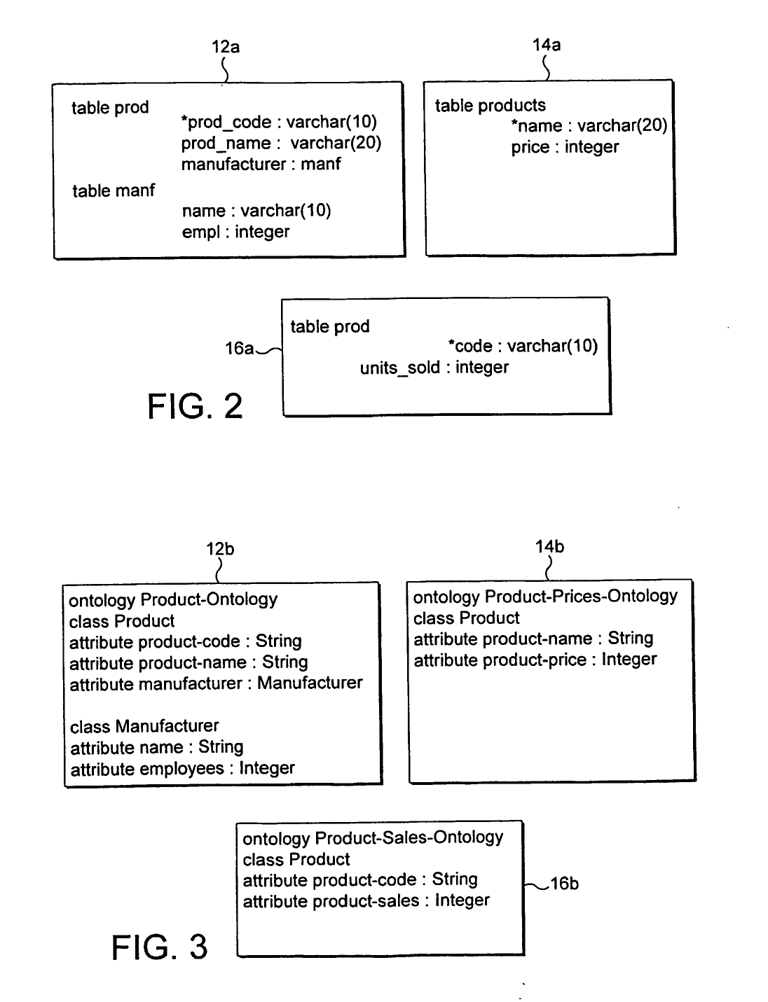

FIG. 2 is a block diagram of database resource schemas according to the present invention;

FIG. 3 is a block diagram of resource ontologies according to the present invention;

FIG. 4 is a block diagram of an application ontology according to the present invention;

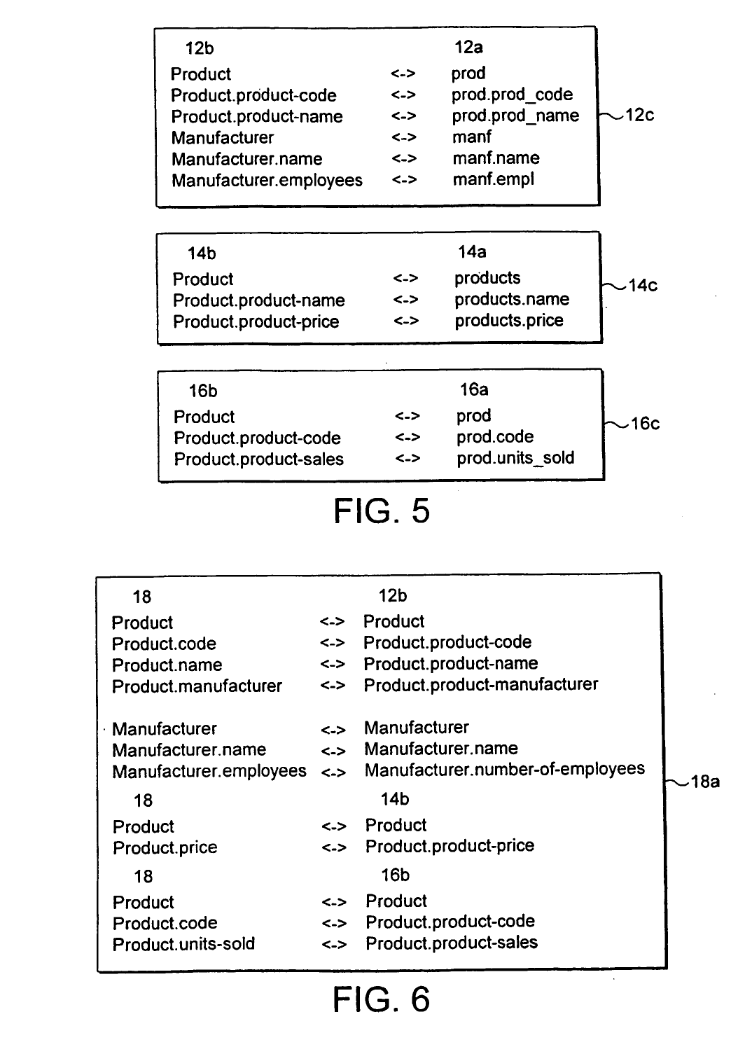

FIG. 5 is a block diagram of a resource ontology-resource schema mapping according to the present invention;

FIG. 6 is a block diagram of an application ontology-resource ontology mapping according to the present invention;

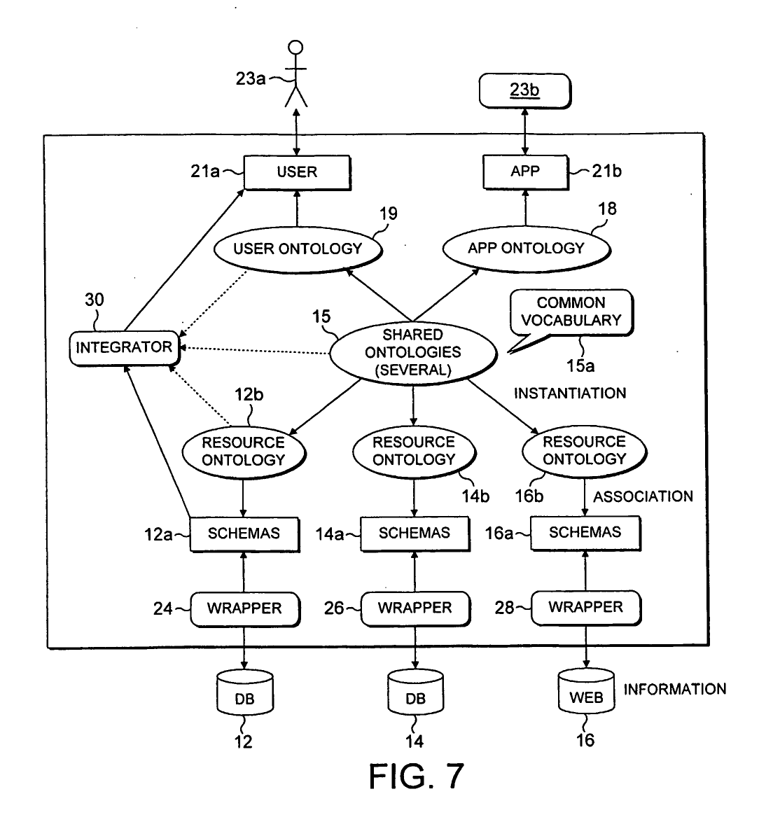

FIG. 7 is a diagram of the information model according to the present invention;

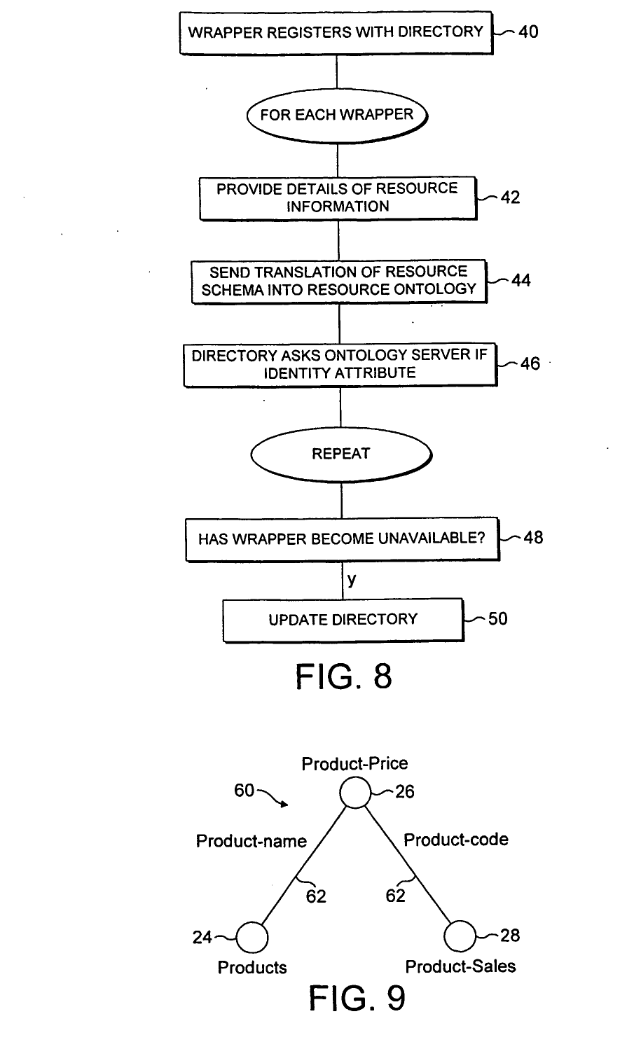

FIG. 8 is a flow diagram showing an initialisation sequence according to the present invention;

FIG. 9 is a node-arc representation of a concept identity graph according to the present invention;

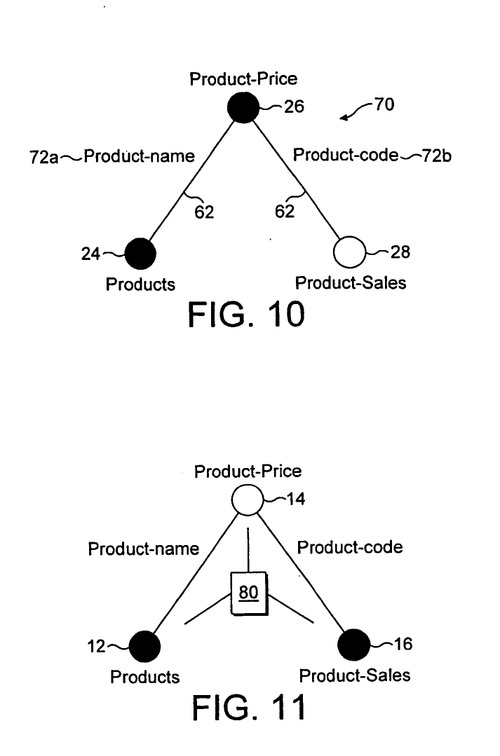

FIG. 10 is a node-arc representation of a solution graph according to the present invention;

FIG. 11 is a node-arc diagram of an alternative solution graph according to the present invention; and

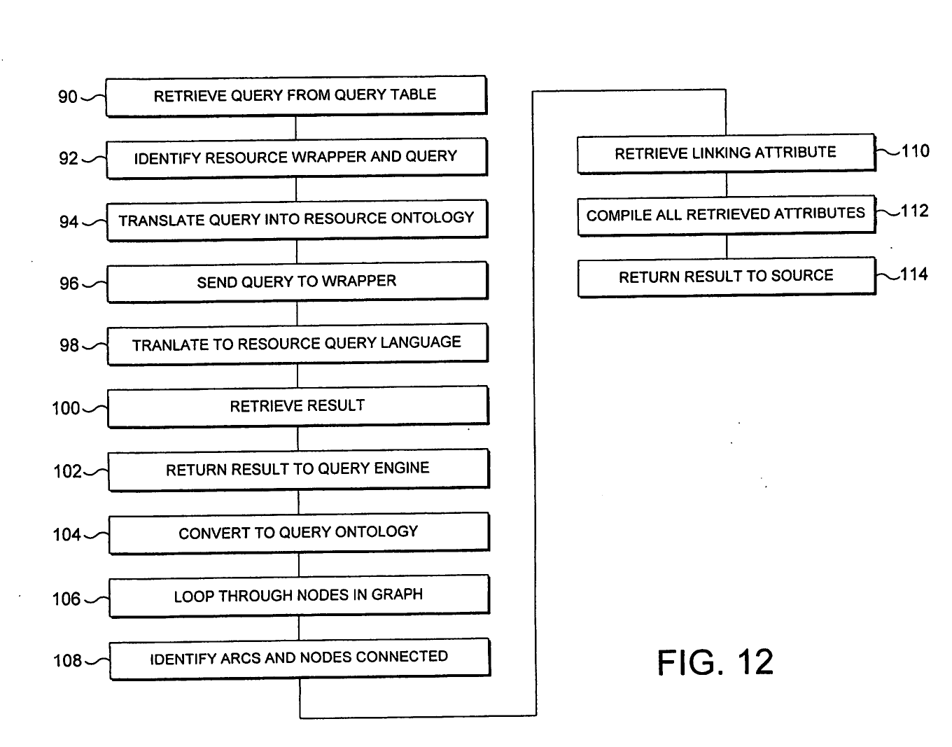

FIG. 12 is a flow diagram representing integration of data retrieved according to the present invention.

In overview, the invention provides a distributed query solution for a network having a plurality of database resources. The network helps users to ask queries which retrieve and join data from more than one resource, which may be of more than one type such as an SQL or XML database.

The solution to the problems of semantic heterogeneity is to formally specify the meaning of the terminology of each system and to define a translation between each system terminologies and an intermediate terminology. We specify the system and intermediate terminologies using formal ontologies and we specify the translation between them using ontology mappings. A formal ontology consists of definitions of terms. It usually includes concepts with associated attributes, relationships and constraints defined between the concepts and entities that are instances of concepts. Because the system is based on the use of formal ontologies it needs to accommodate different types of ontologies for different purposes. For example, we may have resource ontologies, which define the terminology used by specific information resources. We may also have personal ontologies, which define the terminology of a user or some group of users. Another type is shared ontologies, which are used as the common terminology between a number of different systems. The best approach to take in developing an ontology is usually determined by the eventual purpose of the ontology. For example, if we wish to specify a resource ontology, it is probably best to adopt a bottom-up approach, defining the actual terms used by the resource and then generalising from these. However, in developing a shared ontology it will be extremely difficult to adopt a bottom-up approach starting with each system, especially where there are a large number of such systems.

The first step is to create the system and an appropriate architecture is shown in FIG. 1. The server 10 communicates with a plurality of resources 12,14,16, these can for example be databases or the Web resources. In the preferred embodiment discussed below resource 12 comprises a “products database”, resource 14 comprises a “product prices” database and resource 16 comprises a “product sales” database. Although in principle any resource containing structured data can be included, here we discuss only relational databases. The server 10 further comprises an integrater 2 for integration of data derived from the resources, and a query engine 30 arranged to receive a query, construct a set of sub-queries for the relevance resources, translate those into the vocabulary of the relevance resource and pass the received answers to the integrater 2 for integration. An ontology server 20 stores resource ontologies discussed in more detail below with reference to FIG. 3. A mapping server 22 stores mappings between the resource ontology and an application/user ontology. A resource directory server or wrapper directory 32 stores details of the information available from the resources 12,14,16. This information is passed to the directory 32 via respective wrappers 24,26,28 which act as intermediary between a given resource and the server 10. An ontology extractor 4 is further used in initialisation of the network as discussed in more detail below. A user client (not shown) allows the user/application system to use the integrated information. In addition the user can personalise and use shared ontologies. As will be discussed in more detail below, the additional layers of the resource ontology and user ontology provides improved interoperability.

It is worthwhile discussing some definitions at this stage. The system and in particular the ontology is set up to deal optimally with the basic requirement of solving user queries. When a query is received by the query engine, it is treated as a request to retrieve values for a given set of attributes for all “individuals” that are instances of a given “concept” which also satisfy the given conditions. An “individual” is a specific record in a specific resource which may be duplicated, in another form, in another resource (e.g. in the specific example discussed below, two separate database resources may have fields, under differing names, for a common entity such as a product name). A concept definition is in effect a query—the query may be to retrieve all relevant product names for products satisfying given criteria, in which case the individuals are the records in the resources carrying that information. The attributes are then the values (e.g. product names) associated with the relevant records or individuals. The query engine constructs a set of sub-queries to send to the relevant resources in order to solve the user's query. Before the sub-queries are sent, the query engine will translate them into the vocabulary or “ontology” of the relevant resource. After the sub-queries are translated into the query language of the relevant resource (e.g. SQL) the results are passed back to the query engine. Once the query engine has received the results to all sub-queries, it will integrate them and pass the final results to the user client.

Most interaction between a resource and the network occurs via wrappers. A wrapper performs translations of queries expressed in the query syntax and terminology of the resource ontology to queries expressed in the syntax of the resource query language and the terminology of the resource schema. They also perform any translations required to put the results into the terminology of the resource ontology. Although they are configured for particular resources, wrappers are generic across resources of the same type eg wrappers of SQL databases utilise the same code.

Ontologies and database schemes are closely related. There is often no tangible difference, no way of identifying which representation is a schema and which is an ontology. This is especially true for schemas represented using a semantic data model. The main different is one of purpose. An ontology is developed in order to define the meaning of the terms used in some domain whereas a schema is developed in order to model some data. Although there is often some correspondence between a data model and the meaning of the terms used, this is not necessarily the case. Both schemas and ontologies play key roles in heterogeneous information integration because both semantics and data structures are important.

For example, the terminology used in schemas is often not the best way to describe the content of a resource to people or machines. If we use the terms defined in a resource ontology to describe the contents of a resource, queries that are sent to the resource will also use these terms. In order to answer such queries, there needs to be a relationship defined between the ontology and the resource schema. Declarative mappings that can be interpreted are useful here. The structural information provided by schemas will enable the construction of executable queries such as SQL queries.

Examples of SQL resource schema for each of the resources in our example above are given in FIG. 2, in which the schema for the products database is shown at 12a, for the product prices database at 14a and for the product sales database at 16a.

In setting up the network, first, a resource ontology is specified for each resource, which gives formal definitions of the terminology of each resource, ie database 12, 14, 16 connected to the network. Example resource ontologies are given in FIG. 3 for each of the products database 12b, products prices database 14b and product sales database 16b. If the ontology of a resource is not available, it is constructed in order to make the meaning of the vocabulary of the resource explicit. For a database, for example, the ontology will define the meaning of the vocabulary of the conceptual schema. This ontology ensures that commonality between the different resources and the originating query will be available by defining the type of variable represented by each attribute in the schema. In addition, as shown in FIG. 4, an application ontology 18 is defined, providing equivalent information for the attributes required for a specific, pre-defined application, in the present case an application entitled “Product Analysis”. Furthermore a shared ontology is constructed containing definition of general terms that are common across and between enterprises.

Having, by means of the ontology, effectively specified the data-type of each field or attribute in each of the distributed resources, a mapping is then specified between the resource ontology 12b, 14b, 16b and—in the case of a database—the resource schema 12a, 14a, 16a. This is shown in FIG. 5, for each of the products, product prices and product sales databases mappings 12c, 14c, 16c. Although it would be possible to define a mapping directly between an application ontology and the database schema, it is preferred to construct resource ontologies since the mapping between a resource ontology and a resource schema can then be utilised by different user groups using different application ontologies. This requires that relationships are also specified between an application ontology and a resource ontology before the query engine can utilise that resource in solving a query posed in that application ontology, as shown by mapping 18a in FIG. 6.

Whilst it would be ideal to be able to automatically infer the mappings required to perform such translations, this is not always possible. While the formal definitions in an ontology are the best specification of the meaning of terms that we currently have available, they cannot capture the full meaning. Therefore, there must be some human intervention in the process of identifying correspondences between different ontologies. Although machines are unlikely to derive mappings, it is possible for them to make useful suggestions for possible correspondences and to validate human-specified correspondences.

Creating mappings is a major engineering work where re-use is desirable. Declaratively-specifying mappings allows the ontology engineer to modify and re-use mappings. Such mappings require a mediator system that is capable of interpreting them in order to translate between different ontologies. It would also be useful to include a library of mappings and conversion functions as there are many standard translations which could be used, eg converting kilos to pounds, etc.

A developer who wishes to set up a system according to the invention interacts with an engineering client which provides support in the development of the network. This includes the extractor 4, for the semi-automated extraction of ontologies from legacy systems and tools for defining ontologies, for defining mappings between ontologies and between resource ontologies and database schemas. The preferred methodology combines top-down and bottom-up ontology development approaches. This allows the engineer to select the best approach to take in developing an ontology. The top-down process starts with domain analysis to identify key concepts by consulting corporate data standards, information models, or generic ontologies such as Cye or WordNet. Following that, the engineer defines competency questions. The top-down process results in the shared ontologies mentioned above. The bottom-up process starts with the underlying data sources. The ontology extractor 4 is applied to database schemas and application programs to produce initial ontologies. We also provide for the development of application ontologies, which define the terminology of a user group or client application. Application ontologies are defined by specialising the definitions in a shared ontology. Once the ontologies have been defined, they are stored in the ontology server.

The engineer also needs to define mappings between the resource ontologies and the shared ontology for a particular application. The rest of the ontology engineering task is to define mappings between the resource and shared ontologies using ontology mappings. Although we do not infer the mappings automatically, we can utilise ontologies to check the mappings for consistency. The engineer also needs to define mappings between the database schemas and the resource ontologies.

As the invention allows mappings to be specified between the shared and resource ontologies, we have some control over which resources are utilised for data that is available from multiple databases. By only defining mappings between the shared ontology and the parts of the resource ontology for which the resource is a trusted source of information, we can limit the parts of a resource that is used to solve queries.

The mapping server 22 stores the mappings between ontologies which are defined by the engineer in setting up a network. The mapping server also stores generic conversion functions which can be utilised by the engineer when defining a mapping from the ontology to another. These mappings are specified using a declarative syntax, which allows the mappings to be straightforwardly modified and re-used. The query engine queries the mapping server when it needs to translate between ontologies in solving a query.

FIG. 7 shows the information model according to the invention. The respective wrappers 24,26,28 act as intermediaries between the query engine 30 and the resources 12,14,16. Each wrapper is responsible for translating queries sent by the query engine 30 to the query language of the resource. The resource ontologies 12b,14b,16b stored on the ontology server are mapped to the resource schemas 12a,14a,16a via mappings stored in the wrappers. The shared ontologies 15 including common vocabulary 15a mediate between an application ontology 18 and user ontology 19 and the resource ontologies. At the client end user schemas 21a and application schemas 21b provide the interface with the users 23a and applications 23b respectively.

The use of shared ontologies as vocabularies and instantiated (or resource) ontologies to model the underlying information sources provides the relationships between data sources and the resource ontologies allowing differentiation amongst information sources. As a result, dynamic mismatch reconciliation—that is the ability to reconcile conflicting data from different sources and/or select the correct data is achieved. Existing approaches, on the other hand, rely on pre-engineered mismatch reconciliation as a result of which reconciliation is limited to contingencies explicitly catered for at initialisation. This is discussed further later in this document.

Once the various elements of the network have been started, the initialisation sequence begins as shown in FIG. 8. At step 40 each of the wrappers 24, 26, 28 registers with the directory 32 and lets it know at step 42 about the kinds of information that its respective resource 12,14,16 stores. In order to describe the information that is available in a resource 12, 14,16, a wrapper 24, 26, 28 needs to advertise the content of its associated resource with the directory 32. This is done in the terminology of the resource ontology 12b, 14b, 16b. This involves sending a translation into the resource ontology 12b, 14b, 16b of all possible parts of the resource schema 12a, 14a, 16a (i.e. those elements for which a resource ontology-resource schema mapping 12c, 14c, 16c has been defined.)

When the directory 32 receives an advertisement for an attribute of a resource 12, 14, 16, at step 46 it asks the ontology server if the role is an identity attribute for the concept (ie is the attribute listed in the application ontology 18) and the role is marked accordingly in the directory 32 database. Once each wrapper 24, 26, 28 has been initialised, the directory 32 is then aware of all resources 12, 14, 16 that are available and all of the information that they can provide. When a resource 12, 14 16 becomes unavailable (for whatever reason), at step 48 the wrapper 24, 26, 28 will communicate this to the directory 32 which updates at step 50 such that the information stored in the resource 24, 26, 28 will no longer be used by the query engine 30 in query solving.

A detailed description of the ontology translation techniques used is not necessary as the relevant approach will be well known or apparent to the skilled person. However an outline is provided that is sufficient for giving the detail of how a query plan is formed. In order to allow the translation of expressions from the vocabulary of one ontology to that of another, a set of correspondences are specified between the vocabularies of two ontologies. A correspondence between two concepts contains principally: the name of the source and target ontology and the source and target concept names. In some cases the correspondence also contains any pre- and post-conditions for the translation which are important for ensuring that the translation of an expression into the vocabulary of a target ontology has the same meaning as the original expression in the vocabulary of the source ontology. However this last aspect is not relevant to the present example.

The next step is to specify the elements that will be used when the query engine processes queries. In the preferred embodiment an object-oriented framework is used and so the methods associated with each element are also outlined.

A query that is passed to the query engine 30 has the following components:

the ontology in which the terms used in the query are defined; a concept name; a set of names of attributes of the query concept for which values should be returned to the user client; a set of attribute conditions; and a set of role conditions. An attribute condition is a triple <an, op, val> where an is the name of an attribute of the query concept, op is an operator supported by the query language (e.g. ‘<’, ‘>’, ‘=’ and so on) and val is a permissible value for the given attribute or operator. In the specific example described herein are the names of the attributes in each of the conditions is relevant. Each of the role conditions is also a triple (rn, op, sq) where rn is the name of a role, op is an operator (e.g. ‘all’, ‘some’) and sq is a sub-query. The sub-query itself largely conforms to the above guidelines for queries but does not specify the name of the ontology, since this will be the same (it being a sub-set of the main query), or the names of attributes for which values should be returned, since these will be determined automatically. In the specific example discussed herein the operators in role conditions are not relevant.

In the specific example scenario, the user wants to find the name and code of all products which are made by companies with more than 100 employees and which have sold more than 10,000 units. We can represent this query more formally as:

(Product-Analysis-Ontology, Product,
{Product.product-name,Product.product-code}
{Product.product-sales}
{Product.manufacturer,(Manufacturer,{Manufacturer.employees},{ })
)

where the application concept is “Product Analysis”, the attributes or individuals in the application are product name, code and sales and manufacturer employees and the resources are the product, product prices and product sales databases 12, 14, 16.

When the query engine receives a query, a plan is constructed to solve the query given the available information resources. In the following sections, we describe the algorithm for constructing such a plan. Queries are solved recursively. The query engine first tries to solve each member of the set of sub-queries. Any of these that do not themselves have complex sub-queries can be solved directly (if the required information is available).

We utilise a number of data structures in the following description. In order to keep the description as generic as possible, we will assume these data structures are implemented as objects. We refer to the following objects and methods:

Query—represents a query sent to a DOME query engine

Query (c, o)—constructor which takes concept and ontology names as arguments

getOntology( )—returns the name of Me ontology in which the query is famed

getConcept( )—returns the name of the query concept

getRequiredAttributes( )—returns the set of required attributes

getAttribute Conditions( )—returns the set of attribute conditions

add(c)—an overloaded method that adds the component c to the query (where c is a required attribute or an attribute condition)

Hashtable—a table of keys and associated values

Hashtable( )—construct an empty hashtable

put(k, v)—associate the key k with the value v in the table

get(k)—returns the value associated with the key k

hasKey(k)—returns true if the hashtable contains an entry with the key k

Array—a set of elements indexed from 0 to length −1; note that elements of Array can be accessed in the traditional form i.e. to access the ith element of array a, we can write a[i−1]

Array( )—construct an empty array

length( )—returns the number of elements in the array

add(e)—add the element e to the array

remove(e)—remove the element e from the array

contains(e)—returns true if the array contains the element e

Graph

Graph( )—construct an empty graph

is ConnectedSubGraph(n)—return true if the subgraph containing only the nodes in the array n is connected; false otherwise

Result—represent the results from a resource

getResult(a)—retrieve the set of values associated with the given attribute

We first need to identify which resources can answer which parts of the query. This will also tell us whether or not all of the conditions can be answered given the available resources. Given that there may be more than one combination of resources which can answer the query, during this phase we identify what those combinations are with a view to selecting the best combination.

| | |
|---|---|
| Algorithm | identify/Resources |

| | |
|---|---|
| Input | query : Query |

Begin

| | |
|---|---|
| o : = | query.getontology( ) |
| c := | query.getConcept( ) |

requiredAttributes := query.getRequiredAttributes( )
attributeConditions := query.getAttributeConditions( )
compToResTable := new Hashtable( )
resToCompTable = new Hashtable( )
/* identify resources relevant to query parts */
for i := 0 to requiredAttributes.length( ) −I do {

resources := directory.getResources(requiredAttributes[i], c, o)
compToResTable.put(requiredAttributes[i],resources)
for j := 0 to resources.length( ) −I do {

if resToCompTable.hasKey(resources[j]) do {

components = resToCompTable.get(resources[j])
components.add(requiredAttributes[l])

}

else do {

components = new Array( )
components.add(requiredAttributes[i])
resToCompTable.put(resources[j], components)
}

}
for I : = 0 to attributeConditions.length( ) −I do {

resources := directory.getResources(attributeConditions[i], c, o)
compToResTable.put(attributeConditions[i],resources)
for j := 0 to resources.length( ) −I do {

if resToCompTable.hasKey(resources[j]) do {

components = resToCompTable.get(resources[j])
components.add(attributeConditions[i])
}
else do {

components = new Array( )
components.add(attributeConditions[i])
resToCompTable.put(resources[j], components)

}
}
return (compToResTable, resToCompTable)
End

When the algorithm completes, we have identified the resources that are able to answer each condition in the query. These are stored in the hashtable table, the elements of key-value pairs where the key is the name of an attribute or a condition and the value is the set of resources that know about that attributes or condition.

| | |
|---|---|
| Algorithm | generateCombinations |

| | |
|---|---|
| Input | compToResTable : Hashtable |

Begin
allResources = compToResTable.getValues
slice : = new Array(length)
for i : = 0 to length do {
slice[i] := 0
}
hasNext := true
allCombinations : = new Array( )
while (hasNext) {

combination : = now Vector(length)
for i := 0 to length do {

if (i = 0) do {

combination.add(allResources[i] [slice[l]])
}
else {

| for j := 0 to combination.length( ) do { | |
|---|---|
| /* insert in order */ | |
| if | allResources[i] [slice[i]] < combination[j] do { |

combination.insertAt(allResources[i] [slice[i]], j)

break

}

else if allResources[i] [slice[i]] = combination[j] do {
break
}
else if j = combination.length( ) −I do {
combination.add(allResources[i] [slice[i]])
}
}
}
}
if not allCombinations.contains(combination) do {

for i := 0 to allCombinations.length( ) −I do {

if allCombinations[i].length( ) > combination.length( ) do {
allCombinations.insertAt(combination, i)
break
}

}

}
foundNext := false

| | |
|---|---|
| if | slice[length−1] < allResources[length−1].length−1 do { |

slice[length−I] + +

foundNext := true

}
else do {
index : = length−2
while index > = 0 and not foundNext do {

| if | slice[index] < allResources[index].length−1 do { |
|---|---|
| | foundNext = true |
| | slice[index] + + |
| | for i = index + I to length do { |

slice[i] : = 0
}
}

else

index−−

}

}
if not foundNext do {
hasNext : = false
}
}
return allCombinations
End

When this algorithm completes, it returns an array, each element of which is an array containing the names of resources which in combination can be used to answer queries on all of the user query conditions. The elements of the returned array are ordered in increasing length. This next stage is to find the combination which will return results that can be integrated.

Accordingly the relevant structures are defined for subsequent processing of the query.

From this we can construct a “Concept Identity Graph” designated generally 60 as shown in FIG. 9, a directory and resources with wrappers having been established. The concept identity graph 60 represents, by linking them, the resources (ie databases 12, 14,16) via the respective wrappers 24, 26, 28 that have the same primary key attribute (or attributes for composite keys) for a concept. Given some query q, a concept identity graph for the query concept defined in some ontology is constructed.

Input query: Query
Begin
graph = new Graph( )
ontology : = query.getOntology( )
concept : = query.getConcept( )
wrappers : = directory.knows(concept, ontology)
for i := 0 to wrappers.length( ) −I do {
graph.addNode(wrappers[i])
pK := wrappers[i].getPrimaryKey(concept, ontology)
for j := 0 to i −1 do {
if pK = wrappers[j].getPrimaryKey(concept, ontology) do{
graph.addArc(w[i], w[j], pK)
}
}
}
return graph
End

In solving the top-level query in our example, the graph 60 in FIG. 9 is constructed. The wrappers related to resources having the relevant fields or attributes are identified and created as nodes. An arc 62 between nodes is created when the nodes so linked share a key attribute, ie, an attribute demanded by the query. Where there is an arc 62 between a pair of wrappers 24, 26, 28 in the graph 60, we can directly integrate information about the query concept that is retrieved from the resources 12, 14, 16 associated with those wrappers. In the example, information about products which is retrieved from the Product-Price resource 14 can be integrated with information about products retrieved from either the Products resource 12 or the Product-Sales resource 16, but information about products retrieved from the Products and Product-Sales resource cannot directly be integrated as there is no linking arc 62. For this reason, in order to ensure that information from two resources can be integrated, they must at least be in the same sub-graph of the concept identity graph 60, where a sub-graph may be the only graph or one set up to accommodate a sub-query forming part of an overall query (how information retrieved from two resources that are not neighbours in the concept identity graph may be integrated indirectly is discussed below).

We now know what combinations of resources can be used to retrieve information and which resources we can join information from. Next, we need to identify a combination of resources which we can join information from. First, we try to find a combination of resources which corresponds to a connected sub-graph of the concept identity graph, which will indicate that the information from those resources can be joined. If this approach fails, we attempt to introduce additional resources in order to results from other resources. We do this by introducing additional nodes into the graph in order to connect the sub-graph formed by the resources in a combination. These intermediary resources are selected from those not already in the combination.

Combinations of intermediary resources can be generated using an implementation of one of the many known algorithms (we have used Kurtzberg's Algorithm (Kurtzberg, J. (1982) “ACM Algorithm 94: Combination”, Communication of the ACM 5(6), 344). In the algorithm below, we assume such an implementation as the function Combination(n, r) where n is the set of objects to choose from and r is the length of the combinations to generate. This function returns a set of all possible combinations of the set of objects of length r.

| | |
|---|---|
| Algorithm | findCombination |

| | |
|---|---|
| Input | graph : Graph; allCombinations : Array |

Begin
for i := 0 to allCombinations.length( ) −I do {

combination := allCombination[i]
if graph.isConnectedSubGraph(combination) do {

return combination

}
}
}

allNodes := graph.getNodes( )
for i := 0 to allCombinations.length( ) −I do {
combination := allCombination[i]
intermediateNodes = allNodes − combination
for j := 1 to intermediateNodes.length( ) do {

intermediateCombinations = Combination(intermediateNodes, j)
for k := 0 to intermediateCombinations. length( ) −1 do {

resources = combination + intermediateCombinations[k]
if graph.isConnectedSubGraph(resources) do {

return resources

}
}
}

}
End

When this algorithm completes, either the nodes which represent the resources sufficient to answer the query are returned, or a solution to the query has failed to be found. If the former is the case, the queries to be sent to the relevant resources need to be constructed and sent and the results received. In the latter case, the user is informed that the query cannot be answered.

The next stage is to take the chosen combination of resources and to formulate the query that is sent to each. The algorithm to do this needs to retrieve the correct data to (a) solve the user's query, and (b) integrate the results. Taking the combination selected by findCombination, we use the hashtables generated by identifyResources to determine which of the resources can answer which part of the user's query. The arc joining the relevant nodes in the concept identity graph indicates which attributes to use to integrate data from two resources.

Algorithm formResourceQueries
Input graph : Graph; resToCompTable, compToResTable Hashtable;
combination : Array
Begin
resToQueryTable = new Hashtable( )
for i := 0 to compToResTable.length( ) −I do {
queryComponent = compToResTable.getKey(i)
allResources = compToResTable.getEntry(i)
for j := 0 to allResources.length( ) −I do {
if combination.contains(allResources[i]) do {

if resourceQueryTable.hasKey(allResources[i]) do {
query = resourceQueryTable.get(allResources[i])
query.add(queryComponent)

}

else do {

query = new Query( )

query.add(queryComponent)

resourceQueryTable.put(resource,query)

}
}

}

}
/* remove irrelevant nodes from the graph
allNodes = graph.getNodes( )
for i := 0 to allNodes.length( ) −I do {

if not combination.contains(allNodes[i]) do {

graph.removeNode(allNodea[i])

}

}

| | |
|---|---|
| /* | add required attributes that enable data to be integrated |

for i := 0 to combination.length( ) −I do {

arcs = graph.getIncidentArcs(combination[i])
if resourceQueryTable.hasKey(combination[i]) do {

resQuery = resourceQueryTable.get(combination[i])
for j := 0 to arcs.length( ) −I do {

resQuery.add(graph.getLabel(arcs[j]))
}
}

else

resQuery = new Query( )
for j : = 0 to arcs.length( )−1 do {

resQuery.add(graph.getLabel (arcs[j]))

}
resourceQueryTable.add9combination[i], resQuery)

}
return
End

Having shown how conditions and required attributes are allocated to resource queries, the next stage is ensuring that the results to these resource queries can be integrated. The connected sub-graph for which all of the required attributes and conditions can be allocated to a resource query is termed the solution graph 70 in FIG. 10. If some part of the user query has been allocated to a resource 12, 14, 16, we say that the resource is active in relation to a given query. In order to be able to integrate the results from two active resources (designated in the figure by the respective wrapper 24, 26, 28) which are neighbours in the solution graph 70, we need to retrieve values for an identity attribute 72a,b which labels the arc 62 joining the resources. It follows that if all of the active resources are neighbours in the solution graph 72, that is to say, they are linked by an arc 62 designating a shared attribute, provided we retrieve values for the correct attributes, we can integrate the results to all of the resource queries. For example, if there is a solution graph as shown in FIG. 10 with the active resources 24, 26 being shown as solid nodes, in order to integrate results to the two resource queries, it is necessary to retrieve the data for ‘product-name’ from each resource.

However, if an active resource does not have any active neighbours in the solution graph, it will not be possible to integrate the results from the corresponding resource query without some additional information. The solution adopted to this problem is to construct a set of one or more intermediate queries which are sent to the resources to retrieve data that is then used to integrate the results of the resource queries. An intermediate query 6b must be sent to each resource that lies on the path between (a) the active resource without any active neighbours, and (b) the nearest active resource to it. For example, consider the solution graph shown in FIG. 11. In order to integrate data from the active resources product and product sales 12, 16 represented by solid nodes an intermediate query 80 is sent to the ‘Product-Price’ resource 14 which retrieves information on the ‘product-name’ and the ‘product-code’ attributes. If the ‘product-name’ data is retrieved from the ‘Products’ resource 12 and the ‘product-code’ data from the Product-Sales resource 16, the results can be used at the intermediate query 80 to integrate the result from the two resource queries. It may be that in order to make a path between two nodes that are active in a query, multiple intermediate queries are required dependent on the complexity of the query.

The algorithm to determine whether any intermediate queries are required is shown below and is based on determining whether the sub-graph that contains the active nodes is connected. If so, a solution has been found. If not, additional nodes are added until the graph is connected. Nodes are added by generating a combinations of inactive nodes, adding these to the graph and then determining whether the resulting graph is connected. Combinations of increasing length are generated i.e. if there are n inactive nodes in the graph, combinations are generated in order combinations of lengths 1 up to n. Combinations can be generated using an implementation of one of the many known algorithms for generating combinations, for example Kurtzberg's Algorithm (see above).

On receiving a query, a wrapper translates it into the query language of the resource, retrieves the results of the query and sends these results back to the query engine. Once results to all of the sub-queries have been received by the query engine and converted to the query ontology, the integration of those results can begin. This proceeds according to the following algorithm. We assume that the nodes of the graph that was output from formResourceQueries have been replaced with objects of type Result, which are the results from the relevant resources.

| | |
|---|---|
| Algorithm | integrateResults |
| Input | graph : Graph |

Begin
AllResults : = resultGraph.getNodes( )
FoundNodes : = new Array( )
unexploredNodes := new Array( )
foundNodes.add(allResults[0])
unexploredNodes.add(allResults[0])
results := allResults[0]
while not unexploredNodes.isEmpty( ) do {

nodeToExplore := unexploredNodes.remove(0)
neighbours := resultGraph.getNeighbours(nodeToExplore)
for i := 0 to neighbours.length( ) −I do {

if not foundNodes.contains(neighbours[i]) do {

nodeToJoin : = neighbours[i]
newResults = new Result( )
newAttributes : = results.getAttributes( ) +

nodeToJoin.getAttributes( )

newResults.setAttributes(newAttributes)
foundNodes.add(nodeToIntegrate)
unexploredNodes.add(nodeToIntegrate)
joinAttribute : = graph.getLabel(nodeToExplore,

nodeToIntegrate)

data := results.getResult(joinAttribute)
dataToJoin = nodeToJoin.getResult(joinAttribute)
for j := 0 to dataTojoin.length( ) −I do {

if data.contains(dataToJoin[j]) do {

| | |
|---|---|
| row | := |

results.getRow(joinAttribute,dataToJoin[j])

rowToJoin : =

nodeToJoin.getRow(joinAttribute,dataToJoin[j])

newRow = row + rowToJoin
newResults.addRow(newRow)

}
}

}
}

}
End

Once this algorithm completes, we need to return the values for those attributes which are specified as required in the user's query to the user.

The final stage of retrieving and integrating the data is illustrated with reference to FIGS. 7 and 12. In order to send the resource queries, at step 90 the system loops through the resourceQueryTable 31 and retrieves at step 92 each entry in turn, which will consist of the identity of a resource wrapper and the query to be sent to it. It is then necessary to translate each query into the ontology of the resource 12, 14, 16 (step 94) and send this version to the wrapper 24, 26, 28 (step 96). On receiving a query, at step 98 the wrapper 24, 26, 28 translates it into the query language of the resource 12, 14, 16 retrieves the results of the query (step 100) and sends these results back to the query engine 30 (step 102). Each of the individual results then needs to be converted into the ontology of the query at step 104 before they can be integrated to give the results of the query as a whole. Once results to all of the sub-queries have been received and converted to the query ontology at step 104, the integration of those results begins. At step 106 each unexplored node in a solution graph is looped through. At step 108, each arc on the node is identified and the attached node retrieved, and at step 110 the linking attribute is retrieved. Once this is completed, as the graph has been compiled to provide an integrated solution to the query, this technique will ensure that all attributes and attribute conditions are retrieved, in effect by replacing each node with the result retrieved by the wrapper. The query engine can then compile the attributes in the appropriate format at step 112 and return this result to the query source at step 114. An algorithm for dealing with this final step can be compiled in the manner adopted for the other stages discussed above.

As a result of the system described various advantages are obtained. In particular the formation of the concept identity graph is advantageous as a set of solutions is pre-generated, streamlining the identification of a solution. The use of declarative mappings for ontology mappings as ontology to schemer mappings streamlines the distributed query process.

As discussed above, the invention further allows reconciliation of mismatch dynamically rather than using pre-engineered solutions as is known. Technically this amounts to merging ontologies according to a user ontology. This is described further below.

Resource (instantiated) ontologies define the data semantics of their associated information sources. An information source has only one resource ontology, but one resource ontology may serve more than one information source.

Resource ontologies are instantiated ontologies of shared domain ontologies. However, the instantiation may be only partially. For example, certain attributes may have fixed values of defined types of the shared ontology.

As an example:

The shared ontology define Price as

Price:

Amount: value-type

Currency-type: currency-type

Scale-factor: real

We assume all the concepts used in defining Price are also in the shared ontology and they are defined as primitives. The semantics of primitives rely on human-level agreements.

The concept Price could be instantiated in the following ways.

Resource ontology 1:

Price:

Amount: real

Currency-type: GB£

Scale-factor: 1

Resource ontology 2:

Price:

Amount: real

Currency-type: Yan

Scale-factor: 1000

Resource ontology 1:

Price:

Amount: real

Currency-type: US$

Scale-factor: 1

Resource ontology inherits all concepts of its parent ontology. Instantiated concepts override their parent concepts.

User ontology is similar to and plays the same role as resource ontology. Where user ontology 1 is defined as follows:

User ontology 1:

Price:

Amount: integer

Currency-type: Francs

Scale-factor: 1

When resources are merged according to user ontology 1, the price information from different data sources have to be transformed to the terms in user ontology 1. This would need to transform US$, GB£ and Japanese Yen to Francs. Similarly scale factors have to be used; real number has to be translated into integer.

If the user ontology 2 uses US$, all these have to be transformed to US$.

The mismatch algorithm gives steps how ontologies are used and what transformations need to be performed. Existing mappings are assumed already defined in the system.

The algorithm concerns with how to merge results from different resources (e.g. Databases) in terms of a user ontology. Text in italic are comments.

INPUT:User ontology: Ou and a query result type: C

Shared ontology: Os

Result list: RL={O1:C, O2:C, O3:C, . . . }

%% please note that Oi:C is a concept description in Oi terms, and which is equivalent in semantics to C.

OUTPUT: Reconciled result: RR={ } The query result type C is a concept with its semantics defined in the user ontology Ou and all results from resources should be reconciled according to C. The result list RL is the result list from resources before mismatch reconciliation. Element Oi:C means that this value is from a resource whose resource ontology is Oi.

Initialisation:

RR={ };

OntologyServerHandle=Connect to DOME ontology server;

MappingServerHandle=Connect to DOME mapping server;

UserContext=get user contex; % % the user query+user ontology+user preference

SourceContext=null; % % subquery submitted to the source by the query engine

Ci=null;

Ou=the shared ontology;

Map1=null;

Map2=null;

Rules={ } %% all applicable rules

% % userContext holds the whole user query

% % sourceConext holds the subquery processed by the source

% % Ci holds the definition of concept C in Oi

% % Map is a list of mapping rules

RLO=RL;

For each value Oi:C in RLO do the following{

SourceContext=the subquery in terms of Oi sent to source i.

Ci=definition of C in Oi

Map1=all mapping rules relevant to C of Ou and Os;

Map2=all mapping rules relevant to C of Oi and Os;

%% C:Ou →C:Os→C:Oi=Ci

%% Please note that Ci is C in terms of Oi
For each attribute aj of C:Ou{

If aj:Ou maps to a′ of C:Os in Map1 with userContext and
a′:Os maps to a″ of C:Oi in Map2 with sourceContext do
{
get type ruler r1 from Mapping server for transforming

a″ to aj;

add r1 to Rules.
}

else {%% generalise

case 1: get aj′s super attribute and do the above.
case 2: get a′ ′s super attribute and do the above.
case 3: get a″ super attribute and do the above.
case 4: mark a″ value as incompatible.
}

}

}
until RLO = { };
% % transform each result in RL by applying all applicable rules.
RR = result of applying Rules to RL.
Return RR;

The invention further contemplates using XSL (extensible stylesheet language) as a translation tool. In a system which needs to send queries to a number of different database systems, we need to translate a query from the query syntax to the fomat used to query a particular database (e.g. SQL.) We have developed a method of doing this syntax translation using XSL—in particular the XSLT (XSL Transformations language). The first stage in the process is to specify a set of rules in XSLT which specify a mapping from the source syntax to the target syntax. When a query needs to be translated, an XSLT processor is invoked, which applies the rules to the query to generate the target format.

In the system we need to translate the vocabulary of expression from one ontology to another. Essentially, this means keeping the syntax of expression but changing the terms used e.g. replacing a term with a synonym. This kind of translation can also be performed using XSLT. The user adds correspondences between terms, which collectively specify a mapping from one terminology to another. For each correspondence, an XSLT rule is generated and these rules are applied by an XSLT processor to translate expressions from a source ontology to a target ontology.

It will be appreciated that variations of the system can be contemplated. Any number of resources of any database type or structure can be supported with the compilation of appropriate ontologies. Similarly any level of data or query structure, and network configuration or type can be used to implement the system, and the specific examples given in the description above are illustrative only.

1. A database management system comprising a plurality of resources and a database manager having a respective resource ontology for each resource, the manager further comprising a client ontology and a shared ontology.

2. A system as claimed in claim 1 in which the manager further includes a plurality of respective first stores each containing a mapping of a resource ontology to its respective resource contents.

3. A system as claimed in claim 1 in which the manager further includes a directory of the respective resource contents.

4. A system as claimed in claim 1 in which the manager further includes at least one second store containing mappings between terms in the ontologies.

5. A system as claimed in claim 1 in which the database manager comprises a query engine.

6. A system as claimed in claim 1 in which the manager stores information concerning ontology terminologies and relationships therebetween.

7. A system as claimed in claim 6 in which the manager is arranged to provide said terminology/relationship information in response to a query.

8. A system as claimed in claim 1 in which the resource comprises at least one of a database resource or a semi-structured web resource.

9. A method of managing a database comprising a database manager, a plurality of resources comprising the steps of creating a resource ontology for each database resource and storing the resource ontology on the database manager.

10. A method as claimed in claim 9 further including the step of creating a mapping of each resource ontology to its respective resource contents, and storing the mapping in a respective first store.

11. A method as claimed in claim 10 further including the steps of generating queries to each of the first stores to obtain the respective resource contents and compiling therefrom a directory in the manager of the respective resource contents.

12. A method as claimed in claim 9 further including the steps of creating mappings of the resource ontologies onto a pre-defined application ontology and storing the mapping in at least one second store.

13. A method as claimed in claim 9 in which the resource ontology is created based on the respective resource.

14. A method as claimed in claim 9 in which the database manager further comprises a client and the shared ontology is based on the client ontology.

15. A method as claimed in claim 9 in which ontology creation comprises a top-down/bottom-up development process where ontology, database schemas and metadata are connected and differentiated for their roles.

16. A method of managing a database having a plurality of resources and respective ontologies and an intermediate ontology comprising the step of performing mappings between terms in the ontologies.

17. A methods as claimed in claim 16 in which the intermediate ontology comprises at least one of a user ontology, a shared ontology and an application ontology.

18. A method of creating an ontology for a database or database resource comprising a top-down/bottom-up development process where ontology, database schemas and metadata are connected and differentiated for that role.

19. An engineering client for a database management system having a plurality of resources, at least one client, a shared ontology and respective resource ontologies, the engineering client including an ontology creation tool for defining a client driven shared ontology and a resource driven resource ontology.

20. A client as claimed in claim 19 in which the ontology creation tool comprises a wizard which provides a step-by-step guide for creating a resource ontology from a shared ontology and for creating mappings between a resource and a database schemer.

21. An ontology creation tool arranged to provide a step-by-step guide for creating a resource ontology from a shared ontology and for creating mappings between a resource and a database schemer.

22. A tool as claimed in claim 21 comprising a wizard.

23. A computer program configured to implement a system as in claim 1.

24. A computer readable medium comprising instructions for implementing a system as in claim 1.

25. A server or distributed server supporting a system as in claim 1.

26. A database management system comprising a plurality of resources, a respective content description store representative of each resource content and a content description store manager arranged to receive and store content information from each content description store in which the content description store manager is arranged to update content information as resources are added or deleted from the system.

27. A system as claimed in claim 26 in which each resource is associated with a resource ontology and the content description of each resource content is in terms of the respective resource ontology.

28. A system as claimed in claim 27 further comprising a shared ontology wherein each resource ontology is a specialisation of the shared ontology through constraining types defined in the shared ontology or having fixed values.

29. A system as claimed in claim 26 in which at least one of the resources comprises either a database resource or a semi-structured web resource.

30. A system as claimed in claim 26 in which the content description store comprises a resource wrapper.

31. A system as claimed in claim 26 further arranged to compare received content information against stored content information and only update if the content information is not already stored.

32. A database management system comprising a plurality of resources, a respective resource ontology and a shared ontology, the system further comprising an engine for retrieving resource based term semantics as defined in the ontologies.

33. A method of updating a database having a plurality of resources, a respective content description store representative of each resource content and a content description store manager in which each content description store provides content information to the content description store manager and the content description store manager updates content information as resources are added to or deleted from the system.

34. A method as claimed in claim 33 in which the content information provided by the content description store is compared against stored content information and update takes place only if the content information is not already stored.

35. A method of managing a database having a plurality of resources, respective resource strategies and a shared ontology comprising the step of retrieving resource based term semantics as defined in the ontologies.

36. A computer program configured to implement a system as in claim 26.

37. A computer readable medium comprising instructions for implementing a system as in claim 26.

38. A server or distributed server supporting a system as in claim 26.

39. A database management system comprising a database manager including a query engine and a plurality of resources each containing database elements, in which the query engine is arranged to parse an incoming query to identify the elements required for a result, construct a node and link representation of resources including as nodes resources containing the required element and as links elements common to individual nodes and corn an integrated result from the representation.

40. A system as claimed in claim 39 in which the query engine is arranged to compile the integrated result from the data stored as links in the representation.

41. A system as claimed in claim 39 in which the query engine is arranged to identity intermediate links between indirectly linked nodes via intermediate, commonly linked nodes.

42. A system as claimed in claim 41 in which indirectly linked nodes represent resources containing elements other than required elements common with elements in existing nodes.

43. A system as claimed in claim 41 in which the query engine is arranged to create all available intermediate links prior to compilation of an integrated result.

44. A system as claimed in claim 39 in which the query engine is operable to recursively search through the available resources until it is able to construct a node and link representation of resources which cumulatively include all of the elements required by the query, the representation including links between all of the required resources such that the query engine is able to compile an integrated result.

45. A system as claimed in claim 39 in which the resources include at least one of a database resource or a semi-structured web resource.

46. A method of managing a database comprising a database manager including a query engine and a plurality of resources each containing database elements comprising the steps of parsing an incoming query to identify the elements required for a result, constructing a node and link representation of resources including as nodes resources containing the required element and as links elements common to individual nodes and compiling an integrated result from the representation.

47. A method as claimed in claim 46 further including the step of compiling the integrated result from the data stored as links in the representation.

48. A method as claimed in claim 46 further including the step of identifying intermediate links between indirectly linked nodes via intermediate, commonly linked nodes.

49. A method as claimed in claim 48 in which intermediate links are identified between nodes representing resources containing elements other than required elements common with elements in existing nodes.

50. A method as claimed in claim 48 in which all available intermediate links are created prior to compilation of an integrated result.

51. A method as claimed in claim 46 wherein the query engine is operable to recursively search through the available resources until it is able to construct a node and link representation of resources which cumulatively include all of the elements required by the query, the representation including links between all of the required resources such that the query engine is able to compile an integrated result.

52. A computer program configured to implement a system as in claim 39.

53. A carrier medium carrying instructions for implementing a system as in claim 39.

54. A server or distributed server supporting a system as in claim 39.

55. A database management system comprising a database manager and a plurality of resources in which the database manager includes a client ontology having a plurality of client instances, a respective resource ontology for each resource having resource defined instances and a mapping manager having mapping rules between ontologies in which the database manager is arranged to map a client instance and a resource instance to each other according to each mapping rule and validate the mapping rule if the instances match.

56. A system as claimed in claim 55 in which the resource defined instance is marked incompatible if there is no match.

57. A system as claimed in claim 55 further comprising a shared ontology in which the mapping manager has mapping rules between the client ontology and the shared ontology and between the shared ontology and the resource ontology.

58. A system as claimed in claim 56 in which marked incompatible instances are reconciled or transformed through the mapping rules from a client ontology to the shared ontology and from the shared ontology to resource ontologies.

59. A system as claimed in claim 57 in which the client ontology comprises a user ontology which is specialised from the shared ontology instances.

60. A system as claimed in claim 55 in which the resource comprises at least one of a database resource and a semi-structured web resource.

61. A system as claimed in claim 55 in which each instance comprises a specialisation through constraining types or fixed values.

62. A method of managing a database having a plurality of resources, a client ontology having a plurality of client defined instances, a respective resource ontology for each resource having resource defined instances and a mapping manager having mapping rules between ontologies comprising the steps of mapping a client instance and resource instance to each other according to each mapping rule and validating the mapping rule if the instances match.

63. A method as claimed in claim 62 further comprising the step of marking the resource defined instance incompatible if there is no match.

64. A method as claimed in claim 62 further comprising the step of reconciling or transforming an instance marked incompatible through the mapping rules from a client ontology to a shared ontology and from the shared ontology to a resource ontology.

65. A computer program configured to implement a system as in claim 55.

66. A computer readable medium comprising instructions for implementing a system as in claim 55.

67. A server or distributed server supporting a system as in claim 55.

68. A database management system comprising a database manager and a plurality of resources, in which the manager includes a query manager arranged to parse an incoming query for sub-queries, establish a sub-result for each sub-query from a respective resource and integrate the sub-results to obtain an overall query result.

69. A system as claimed in claim 68 in which the query engine contains a resource ontology for each resource and the sub-result is established via the resource ontologies.

70. A system as claimed in claim 68 in which the query engine is arranged to parse a query to identify the elements required for a sub-query sub-result, construct a node and link representation of resources including as nodes resources containing the required element and as links elements common to individual nodes and compile an integrated sub-result from the representation.

71. A system as claimed claim 68 in which the resource comprises at east one of a database resource or a semi-structured web resource.

72. A method of managing a database comprising a database manager and a plurality of database resources comprising the steps of parsing an incoming query for sub-queries, establishing a sub-result for each sub-query from a respective resource and integrating the sub-results to obtain an overall query result.

73. A method as claimed in claim 72 in which the query engine contains a resource ontology for each database resource and in which the step of establishing the sub-result is carried out via the resource ontologies.

74. A method as claimed in claim 72 further including the steps of parsing a query to identify the elements required for a sub-query sub-result, constructing a node and link representation of database resources including as nodes resources containing the required element and as links elements common to individual nodes and compiling an integrated sub-result from the representation.

75. A computer program configured to implement a system in claim 68.

76. A computer readable medium comprising instructions for implementing a system as in claim 68.

77. A server or distributed server supporting a system as in claim 68.
